(19) United States
(12) Patent Application Publication
(10) Pub. No.: US 2026/0329094 A1
(43) Pub. Date: Oct. 22, 2026

(54) OPTIMIZED IN-COUPLER GRATING OUTLINE OF AUGMENTED REALITY WAVEGUIDE COMBINERS

(71) Applicant: Applied Materials, Inc., Santa Clara, CA (US)

(72) Inventors: Kunal SHASTRI, Santa Clara, CA (US); Evan WANG, Palo Alto, CA (US); David Alexander SELL, Santa Clara, CA (US)

(21) Appl. No.: 19/651,391

(22) Filed: Apr. 17, 2026

Related U.S. Application Data
(60) Provisional application No. 63/790,846, filed on Apr. 18, 2025.

(51) Int. Cl. G02B 27/01; G02B 6/34

(52) U.S. Cl. CPC G02B 27/0172; G02B 6/34

(57) ABSTRACT

Waveguides having an input coupling grating with curved corner regions are disclosed herein. The input coupling grating is configured to receive a square or rectangular emission pupil and couple the emission pupil into the waveguide. The input coupling grating has a boundary. The boundary includes four edge regions and four corner regions connecting adjacent edge regions. The corner regions define a limiting boundary of the emission pupil. Each respective corner region has a respective curve. Each respective curve, in a local coordinate system, is defined by a curvature equation, xⁿ+yⁿ=Rⁿ, for a value of n, wherein x and y are orthogonal coordinates defined in the local coordinate system associated with the respective corner region. An origin of the local coordinate system is located at the center point of the input coupling grating aligned with the emission pupil.

### CROSS-REFERENCE TO RELATED APPLICATIONS

This application claims the benefit of U.S. Provisional Patent Application Ser. No. 63/790,846, filed Apr. 18, 2025, which is incorporated by reference herein in its entirety.

### BACKGROUND

### Field

Embodiments of the present disclosure generally relate to methods of forming waveguides for augmented, virtual, and mixed reality. More specifically, embodiments described herein provide for optical device systems, waveguides, and a method of forming waveguides having an input coupling grating with curved corner regions.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhances or augments the environment that the user experiences. As an emerging technology, there are many challenges and design constraints with augmented reality.

In many virtual-reality, augmented-reality, and mixed-reality display systems, optical waveguides are used to deliver image light from a display engine to a user's eye in a compact form factor suitable for head-mounted displays. An optical waveguide generally includes a transparent substrate configured to receive light from a light source or microdisplay, guide that light through the substrate by internal reflection, and redirect the light toward the user's eye using one or more optical coupling structures. While waveguides enable lightweight, compact, and visually integrated AR/VR displays, their design and manufacture present significant challenges, including optical efficiency, uniformity, field of view, color performance, and the precision and scalability of waveguide fabrication processes.

Accordingly, what is needed in the art are waveguides and methods of forming waveguides.

### SUMMARY

In one embodiment, a waveguide is disclosed. The waveguide includes an input coupling grating disposed on or in a waveguide substrate. The input coupling grating has a center point to be aligned with an emission pupil that is square or rectangular. The input coupling grating is configured to receive the emission pupil and couple the emission pupil into the waveguide. The input coupling grating has a boundary. The boundary includes four edge regions and four corner regions connecting adjacent edge regions. The corner regions define a limiting boundary of the emission pupil. Each respective corner region has a respective curve. Each respective curve, in a local coordinate system, is defined by a curvature equation, xⁿ+yⁿ=Rⁿ, for a value of n, wherein x and y are orthogonal coordinates defined in the local coordinate system associated with each respective corner region. An origin of the local coordinate system is located at the center point of the input coupling grating aligned with the emission pupil.

In another embodiment, an optical device system is disclosed. The optical device system includes a light engine and a waveguide. The light engine is configured to project an emission pupil that is square or rectangular. An input coupling grating is disposed on or in the waveguide substrate. The input coupling grating has a center point to be aligned with the light engine. The input coupling grating is configured to receive the emission pupil and couple the emission pupil into the waveguide. The input coupling grating has a boundary. The boundary includes four edge regions and four corner regions connecting adjacent edge regions. The corner regions define a limiting boundary of the emission pupil. Each respective corner region has a respective curve. Each respective curve, in a local coordinate system, is defined by a curvature equation, xⁿ+yⁿ=Rⁿ, for a value of n, wherein x and y are orthogonal coordinates defined in the local coordinate system associated with each respective corner region. An origin of the local coordinate system is located at the center point of the input coupling grating aligned with the emission pupil.

In yet another embodiment, a method of forming a waveguide is disclosed. The method includes measuring an area of an emission pupil of a light engine. The method further includes defining a boundary of an input coupling grating. The boundary includes a plurality of edge regions and a plurality of corner regions connecting adjacent edge regions. The corner regions define a limiting boundary of the emission pupil. The method includes configuring the boundary to correspond to the area of the emission pupil by defining each respective corner region. Each respective corner region has a respective curve, in a local coordinate system, defined by a curvature equation, xⁿ+yⁿ=Rⁿ, for a value of n, wherein x and y are orthogonal coordinates defined in the local coordinate system associated with the respective corner region. An origin of the local coordinate system is located at the center point of the input coupling grating aligned with the emission pupil. The method further includes forming the input coupling grating having the boundary on a waveguide substrate.

### BRIEF DESCRIPTION OF THE DRAWINGS

So that the manner in which the above recited features of the present disclosure can be understood in detail, a more particular description of the disclosure, briefly summarized above, may be had by reference to embodiments of the disclosure, some of which are illustrated in the appended drawings. It is to be noted, however, that the appended drawings illustrate only exemplary embodiments of the disclosure and are therefore not to be considered limiting of its scope, as the disclosure may admit to other equally effective embodiments.

FIG. 1A illustrates a front view of an optical device system, according to one or more embodiments disclosed herein.

FIG. 1B illustrates a schematic, cross-sectional view of an optical device system including the waveguide shown in FIG. 1A, according to one or more embodiments disclosed herein.

FIG. 2A illustrates a schematic, top view of an input coupling grating having a boundary with a circular shape, according to one or more embodiments disclosed herein.

FIG. 2B illustrates a schematic, top view of an input coupling grating having a boundary with a rectangular shape, according to one or more embodiments disclosed herein.

FIGS. 3A-3C illustrate schematic, top views top views of an input coupling grating having a boundary with curved corner regions, according to one or more embodiments disclosed herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to methods of forming waveguides for augmented, virtual, and mixed reality. More specifically, embodiments described herein provide for optical device systems, waveguides, and a method of forming waveguides having an input coupling grating with curved corner regions.

Many of the details, dimensions, angles and other features shown in the figures are merely illustrative of particular embodiments. Accordingly, other embodiments can have other details, components, dimensions, angles and features without departing from the spirit or scope of the present disclosure. In addition, further embodiments of the disclosure can be practiced without several of the details described below.

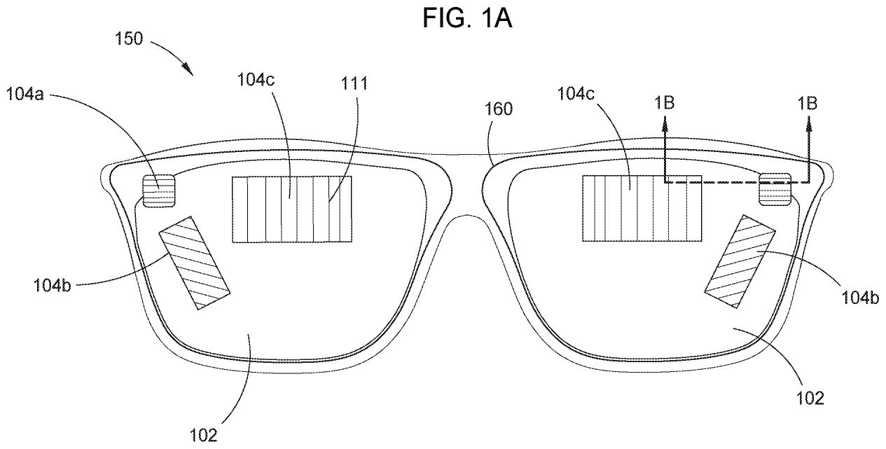

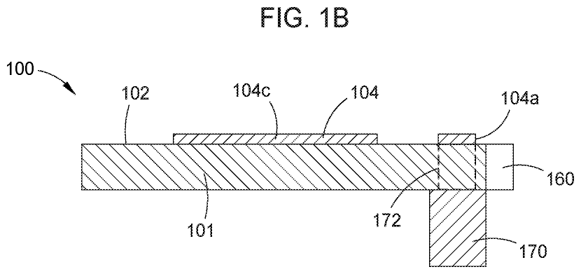

FIG. 1A illustrates a front view of an optical device system 150, according to one or more embodiments disclosed herein. In some embodiments, the optical device system 150 includes a waveguide 100 supported by a wearable frame 160 and configured to present visual information to a user. The optical device system 150 shown in FIG. 1A illustrates a representative implementation in eyewear form, however, the systems and techniques described herein are not limited to eyeglasses and may be used in a wide variety of optical devices. Such optical devices include, but are not limited to, smart glasses, head-mounted displays, augmented reality devices, virtual reality devices, mixed-reality devices, protective eyewear, helmets, visors, medical imaging systems, industrial vision systems, mobile devices, handheld electronic devices, and security or monitoring systems. As described in further detail below, the optical device system 150 includes gratings 104 arranged to couple light from a light engine into the waveguide 100, propagate the light within the waveguide 100, and output images to a user.

It is understood that the waveguide 100 described herein is an exemplary waveguide and that other waveguides may be used with or modified to accomplish aspects of the present disclosure. The waveguide 100 includes a plurality of grating structures 111. The grating structures 111 may be disposed over, under, or on a first surface 102 of a waveguide substrate 101, or disposed in the waveguide substrate 101. The grating structures 111 are nanostructures and have sub-micron critical dimensions (e.g., a width less than 1 micrometer). Regions of the grating structures 111 correspond to one or more gratings 104. In one embodiment, which can be combined with other embodiments described herein, the waveguide 100 includes at least a first grating 104a corresponding to an input coupling grating and a third grating 104c corresponding to an output coupling grating. The gratings 104 may be disposed in, on, or over the waveguide substrate 101. In another embodiment, which can be combined with other embodiments described herein, the waveguide 100 further includes a pupil expansion grating 104b. The pupil expansion grating 104b corresponds to a pupil expansion grating or a fold grating.

The waveguide substrate 101 may also be selected to transmit a suitable amount of light of a desired wavelength or wavelength range, such as one or more wavelengths from about 100 to about 3000 nanometers. Without limitation, in some embodiments, the waveguide substrate 101 is configured such that the waveguide substrate 101 transmits greater than or equal to about 50% to about 100%, of an infrared to ultraviolet region of the light spectrum. The waveguide substrate 101 may be formed from any suitable material, provided that the waveguide substrate 101 can adequately transmit light in a desired wavelength or wavelength range and can serve as an adequate support for the waveguide 100 described herein. Substrate selection may include optical device substrates of any suitable material, including, but not limited to, amorphous dielectrics, non-amorphous dielectrics, crystalline dielectrics, silicon oxide, polymers, and combinations thereof. In some embodiments, which may be combined with other embodiments described herein, the waveguide substrate 101 includes a transparent material. In one embodiment, which may be combined with other embodiments described herein, the waveguide substrate 101 is transparent with an absorption coefficient smaller than 0.05. In one embodiment, which may be combined with other embodiments described herein, the waveguide substrate 101 is transparent with an absorption coefficient smaller than 0.001. Suitable examples may include silicon (Si), silicon dioxide (SiO₂), fused silica, quartz, silicon carbide (SiC), germanium (Ge), silicon germanium (SiGe), indium phosphide (InP), gallium arsenide (GaAs), gallium nitride (GaN), sapphire, lithium tantalate (LiTaO₃), lithium niobate (LiNbO₃), or combinations thereof. In some embodiments, which may be combined with other embodiments described herein, the waveguide substrate 101 has a substrate refractive index greater than 1.4, such as greater than 1.6, such as about 1.8, or about 2.0. In some embodiments, which may be combined with other embodiments described herein, the waveguide substrate 101 has a substrate refractive index greater than 2.0 when made of a crystalline material. The crystalline material includes silicon carbide or lithium niobate.

In some embodiments, the grating structures 111 are disposed in the waveguide substrate 101. In other embodiments, the grating structures 111 are disposed on or over the waveguide substrate 101. In these embodiments, the grating structures 111 include a device material. The device material includes, but is not limited to, silicon carbide (SiC), silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), silicon mononitride (SiN), silicon oxynitride (SiON), barium titanate (BaTiO₃), diamond like carbon (DLC), hafnium(IV) oxide (HfO₂), lithium niobate (LiNbO₃), silicon carbon-nitride (SiCN), or combinations thereof.

In operation of the waveguide 100 a virtual image is projected from a near-eye display, such as a microdisplay, to the input coupling grating 104a. The grating structures 111 of the input coupling grating 104a in-couple the incident beams of light of the virtual image and diffract the incident beams to the pupil expansion grating 104b. The diffracted beams undergo total-internal-reflection (TIR) until through the waveguide 100 until the diffracted beams come in contact with grating structures 111 of the pupil expansion grating 104b. The diffracted beams from the input coupling grating 104a incident on the pupil expansion grating 104b are split into a first portion beams refracted back or lost in the waveguide 100, a second portion beams that undergo TIR in the pupil expansion grating 104b until the second portion beams contact another structure of the plurality of grating structures 111 of the pupil expansion grating 104b, and a third portion of beams that are coupled through the waveguide 100 to the output coupling grating 104c. The beams of the second portion of beams that undergo TIR in the pupil expansion grating 104b continue to contact structures of the plurality of structures until the either the intensity of the second portion of beams coupled through the waveguide 100 to the pupil expansion grating 104b is depleted, or remaining second portion of beams propagating through the pupil expansion grating 104b reach the end of the pupil expansion grating 104b.

The beams pass through the waveguide 100 to the output coupling grating 104c and undergo TIR in the waveguide 100 until the beams contact a structure of the plurality of gratings 104 of the output coupling grating 104c where the beams are split into beams that are refracted back or lost in the waveguide 100, beams that undergo TIR in the output coupling grating 104c until the beams contact another structure of the plurality of gratings 104, or beams that are out-coupled from the waveguide 100 to the user's eye. The beams that undergo TIR in the output coupling grating 104c continue to contact structures of the plurality of gratings 104 until the either the intensity of the beams pass through the waveguide 100 to the output coupling grating 104c is depleted, or remaining beams propagating through the output coupling grating 104c have reached the end of the output coupling grating 104c. The beams of the virtual image are propagated from the output coupling grating 104c to overlay the virtual image over the ambient environment.

FIG. 1B illustrates a schematic, cross-sectional view of an optical device system 150 including the waveguide 100 shown FIG. 1A, according to one or more embodiments disclosed herein. The virtual image may be projected to the input coupling grating 104a from a light engine 170. The light engine 170 may include one or more image sources, projection optics, illumination elements, and/or beam-shaping components configured to emit or project light toward the input coupling grating 104a. The light engine 170 may be disposed on either side of the waveguide substrate 101.

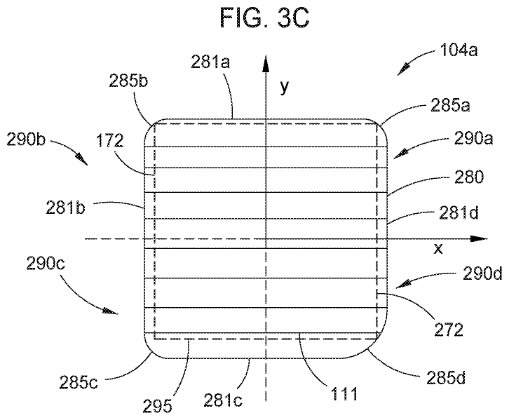

The light engine 170 emits or projects an emission pupil 172. The emission pupil 172 is an effective spatial shape of light produced by the light engine 170. The emission pupil 172 passes through the waveguide substrate 101 to the input coupling grating 104a. The emission pupil 172 may be defined by optics within the light engine 170, by an aperture stop, or by effective pupil-forming elements of a projection system. As described in further detail below, the emission pupil 172 may have a non-circular shape, such as a rectangular or square shape, depending on a configuration of the light engine 170 and associated projection optics. The emission pupil 172 has a limiting boundary 272 (shown in FIGS. 3A-3C). The limiting boundary 272 of the emission pupil 172 may include four corners.

The light emitted or projected from the light engine 170 is incident on the input coupling grating 104a, where the light is diffracted into the waveguide 100 and propagated by total internal reflection toward the pupil expansion grating 104b and the output coupling grating 104c. The input coupling grating 104a is configured to receive the emission pupil 172 and couple the emission pupil 172 into the waveguide 100. The efficiency with which light from the emission pupil 172 is coupled into the waveguide 100, as well as the image quality of the virtual image presented to the user, can depend on a correspondence between a boundary of the input coupling grating 104a and the shape of the emission pupil 172.

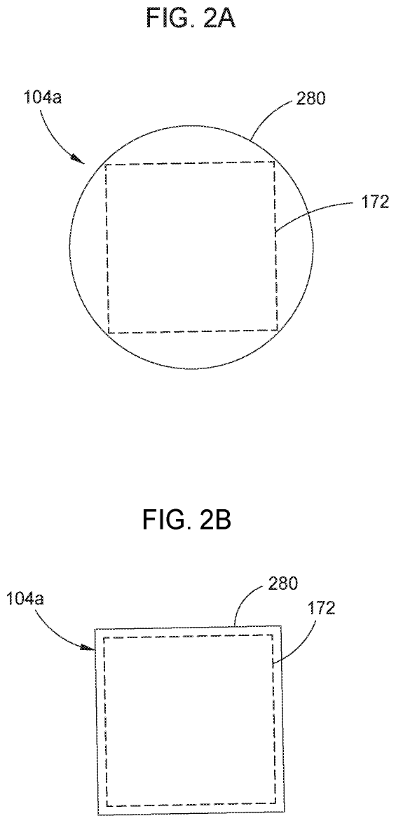

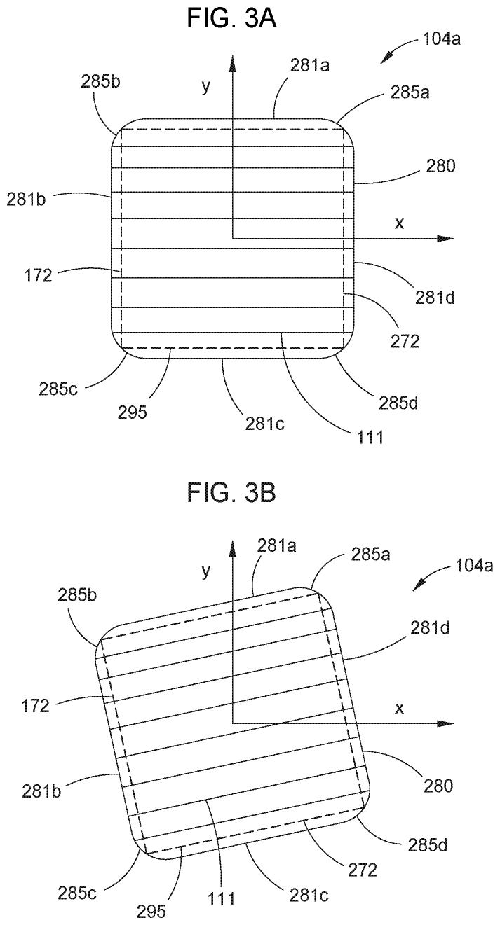

FIG. 2A illustrates a schematic, top view of an input coupling grating 104a having a boundary 280 with a circular shape, according to one or more embodiments disclosed herein. While discussions herein are directed to an input coupling grating 104a, it should be appreciated that the boundary 280 may be matched to the shape of other gratings 104 of the waveguide 100, such as the second grating 104b (pupil expansion grating or the fold grating) or the output coupling grating 104c. Light corresponding to the emission pupil 172 may be coupled by the pupil expansion grating 104b to expand the spatial distribution of the light within the waveguide 100. The expanded light may be coupled out of the waveguide 100 by the output coupling grating 104c to form an image for a user.

In some embodiments, a mismatch between the shape of the emission pupil 172 and the boundary 280 of the input coupling grating 104a may result in reduced coupling efficiency, increased optical loss, image flare, and/or other image artifacts. Accordingly, one or more embodiments disclosed herein are directed to configurations of the boundary 280 of the input coupling grating 104a that are shaped relative to the emission pupil 172 to improve coupling efficiency while reducing image flare and preserving virtual image quality.

FIG. 2B illustrates a schematic, top view of an input coupling grating 104a having a boundary 280 with a rectangular shape, according to one or more embodiments disclosed herein.

While a boundary 280 having a rectangular shape may more closely match a rectangular or square emission pupil 172 than a circular boundary, sharp corner transitions of the rectangular boundary may introduce diffraction effects and image flare. Accordingly, shaping the corner regions of the boundary 280 to be more curved will reduce image flare while maintaining efficient coupling of light into the waveguide 100.

FIGS. 3A-3C illustrate schematic, top views of an input coupling grating 104a having a boundary 280 with curved corner regions 285a, 285b, 285c, 285d, according to one or more embodiments disclosed herein. As described above, the boundary 280 may be configured to correspond to a shape of the emission pupil 172 of the light engine 170 and to reduce image flare associated with coupling light into the waveguide 100.

In one or more embodiments, the boundary 280 includes a plurality of edge regions 281a, 281b, 281c, 281d and a plurality of corner regions 285a, 285b, 285c, 285d connecting adjacent edge regions 281a, 281b, 281c, 281d. The edge regions 281a, 281b, 281c, 281d may correspond to sides of the emission pupil 172. The corner regions 285a, 285b, 285c, 285d provide transitions between adjacent edge regions 281a, 281b, 281c, 281d. The edge regions 281a, 281b, 281c, 281d are substantially linear. The corner regions 285a, 285b, 285c, 285d has a curvature configured to transition between adjacent edge regions 281a, 281b, 281c, 281d. In one or more embodiments, the boundary 280 includes four edge regions 281a, 281b, 281c, 281d and four corner regions 285a, 285b, 285c, 285d connecting adjacent edge regions 281a, 281b, 281c, 281d. As described in further detail below, the shape of the corner regions 285a, 285b, 285c, 285d may be controlled to balance coupling efficiency and virtual image quality by reducing optical artifacts associated with sharp boundary transitions. The boundary 280 may be configured to be separated from an edge of the emission pupil 172 by a distance 295 within 10% of a width or height of the emission pupil 172. In some embodiments, the corner regions 285a, 285b, 285c, 285d define the limiting boundary 272 of the emission pupil 172. In some embodiments, each of the four corners of the limiting boundary 272 of the emission pupil 172 coincides or intersects with a respective corner region 285a, 285b, 285c, 285d of the boundary 280. In these embodiments, the distance 295 at each of the corners is zero. In some embodiments, the distance 295 is not equal in each edge region 281a, 281b, 281c, 281d and/or corner region 285a, 285b, 285c, 285d.

In one or more embodiments, the boundary 280 is defined using a local coordinate system having an origin located at or near a center point of the emission pupil 172. The center point of the boundary 280 is configured to be aligned with the light engine 170. In some embodiments, the center point of the boundary 280 is configured to be aligned with the center of the emission pupil 172. In this coordinate system, portions of the boundary 280, including one or more corner regions 285a, 285b, 285c, 285d, may be defined using a curvature equation. The curvature of the corner regions 285a, 285b, 285c, 285d is selected to provide smooth transitions between edge regions while maintaining a boundary 280 shape that corresponds to the emission pupil 172.

Defining the boundary 280 includes measuring the shape or area of the emission pupil 172 and selecting curvature parameters as further discussed below. The curvature parameters are selected such that the boundary 280 is configured to correspond to the measured shape or area of the emission pupil 172. Forming the waveguide 100 with a boundary 280 as described herein such that the corner regions 285a, 285b, 285c, 285d reduce image flare associated with coupling light into the waveguide 100 relative to a waveguide 100 including a boundary 280 having sharp corners.

Each corner region 285a, 285b, 285c, 285d includes a respective curve. Each respective curve of each corner region 285a, 285b, 285c, 285d of the boundary 280 may be defined by the equation: xⁿ+yⁿ=Rⁿ. In the curvature equation, x and y are orthogonal coordinates defined in the local coordinate system associated with each respective corner region 285a, 285b, 285c, 285d. The coordinates, x and y, are points along the boundary 280, as determined by the selected curvature equation. In the curvature equation, n is an integer. In some embodiments, n is an integer between 2 and 100. The lower the value of n, the more the equation approximates a circular shape. Thus, to achieve more curved corner regions 285a, 285b, 285c, 285d, the value of n should be lower. For example, an n value of 2 results in a perfect circle. Accordingly, n corresponds to the curvature of the respective curves of each corner region 285a, 285b, 285c, 285d. In some embodiments, n is an even integer. In the curvature equation, R represents the radius of the boundary 280. The curvature equation is defined as to the boundary 280 such that the corner regions 285a, 285b, 285c, 285d include curvature and the edge regions 281a, 281b, 281c, 281d remain substantially linear.

In some embodiments, the shape of the boundary 280 of the input coupling grating 104a may be described as a superellipse. A superellipse is defined by semi-diameters and/or semi-axes, each of the semi-diameters and/or semi-axes intersects the center of the superellipse. The following formula may represent the superellipse: |x/a|ⁿ+|y/b|ⁿ=1. In the above formula, a is a positive number that represents one semi-diameter or semi-axis which runs horizontally parallel to the x-axis. In the above formula, b is a positive number that represents one semi-diameter or semi-axis which runs vertically parallel to the y-axis. As n increases in value, the superellipse becomes more rectangular in shape. As n decreases in value, the superellipse becomes more pointed in shape, nearing the shape of a diamond and/or rhombus.

As shown in FIG. 3B, in some embodiments, the boundary 280 is rotated relative to the waveguide 100 such that it corresponds to the shape or orientation of an emission pupil 172 that is rotated about the origin of the coordinate system. Rotation of the boundary 280 may be combined with any of the embodiments disclosed herein, including embodiments having corner region 285a, 285b, 285c, 285d specific curvature, as detailed below in the discussion of FIG. 3C.

As shown in FIG. 3C, in some embodiments, the boundary 280 is defined by multiple equations for different regions 290a, 290b, 290c, 290d of the boundary 280. FIG. 3C illustrates a boundary 280 defined by four different regions 290a, 290b, 290c, 290d, each region 290a, 290b, 290c, 290d corresponding to one of four quadrants of the emission pupil 172. It should be appreciated that the boundary 280 may be divided into any number of regions 290a, 290b, 290c, 290d and the regions 290a, 290b, 290c, 290d need not be of equivalent length. For example, one equation may represent one half of the boundary 280, while two other equations each represent a quarter of the boundary 280.

As shown in FIG. 3C, the fourth corner region 285d is defined by a different equation than the other corner regions 285a, 285b, 285c such that it has a greater degree of curvature. The use of different curvature equations in different regions enables localized control of curvature of the boundary 280, allowing the boundary 280 to more closely respond to emission pupils 172 which do not have a uniform shape. For example, one corner of the emission pupil 172 may have a greater degree of curvature. In this example, a different equation is needed to more closely match the shape of the boundary 280 in this region to the shape of the emission pupil 172 in this region. In these embodiments, the curvature equations defining different corner regions 285a, 285b, 285c, 285d share the same radius parameter R while having different values of n. In some embodiments, the value of R is the same for each corner region 285a, 285b, 285c, 285d and the value of n differs between at least two corner regions 285a, 285b, 285c, 285d. In some embodiments, each corner region 285a, 285b, 285c, 285d includes a different value of n.

In one or more embodiments, a corner region 285a, 285b, 285c, 285d of the boundary 280 closest to a pupil expansion grating 104b or an output coupling grating 104c may be defined to have a greater degree of curvature than another corner region 285a, 285b, 285c, 285d. As shown in FIG. 3C, the corner region 285d is defined by a curvature equation having a value of n greater than the value of n of the curvature equations of the other corner regions 285a, 285b, 285c. Increasing curvature in selected corner regions 285a, 285b, 285c, 285d may reduce image flare and diffraction effects associated with the propagation of light within the waveguide 100 as the light travels between gratings 104.

Although FIG. 3C illustrates an embodiment in which different curvature equations are applied to different corner regions 285a, 285b, 285c, 285d, the number of regions 290a, 290b, 290c, 290d, the assignment of curvature parameters, and the correspondence between regions 290a, 290b, 290c, 290d of the boundary 280 and portions of the emission pupil 172 may be varied depending on elements including, but not limited to, the configuration of the light engine 170, the orientation of the emission pupil 172, and the optical characteristics of the waveguide 100.

In one or more embodiments, a method of forming the waveguide 100 includes determining characteristics of the light engine 170 prior to forming the input coupling grating 104a. In some embodiments, the method includes measuring an area of the emission pupil 172 of the light engine 170. The area of the emission pupil 172 may be determined based on projection optics of the light engine 170, an aperture stop, or light distribution measurements at a plane corresponding to an input surface of the waveguide 100.

The method further includes defining a boundary 280 of an input coupling grating 104a. The boundary 280 includes a plurality of edge regions 281a, 281b, 281c, 281d and a plurality of corner regions 285a, 285b, 285c, 285d connecting adjacent edge regions 281a, 281b, 281c, 281d. In some embodiments, the corner regions 285a, 285b, 285c, 285d collectively define a limiting boundary 272 of the emission pupil 172, such that the boundary 280 circumscribes or approximates the measured area of the emission pupil 172.

In one or more embodiments, configuring the boundary 280 to correspond to the area of the emission pupil 172 includes defining each respective corner region 285a, 285b, 285c, 285d using a curvature profile selected to balance coupling efficiency and image quality. Each respective corner region 285a, 285b, 285c, 285d may be defined by a respective curve in a local coordinate system. The curve is defined by a curvature equation of the form: xⁿ+yⁿ=Rⁿ. wherein n is a selected value corresponding to a degree of curvature of each respective curve. In such embodiments, x and y are orthogonal coordinates defined in the local coordinate system associated with the respective corner region 285a, 285b, 285c, 285d. An origin of the local coordinate system may be located at a center point of the input coupling grating 104a, which in some embodiments is aligned with a center of the emission pupil 172. The value of n may be selected based on the measured area and shape of the emission pupil 172 to control curvature of the corner regions 285a, 285b, 285c, 285d.

The method further includes forming the input coupling grating 104a having the defined boundary 280 on the waveguide substrate 101. Forming the input coupling grating 104a may include patterning a plurality of grating structures 111 in or on the waveguide substrate 101 using lithography, etching, embossing, nano-imprinting, or other suitable fabrication techniques, such that the resulting input coupling grating 104a includes the defined edge regions 281a, 281b, 281c, 281d and corner regions 285a, 285b, 285c, 285d corresponding to the configured boundary 280.

Embodiments disclosed herein provide improved optical performance in waveguide-based display systems by configuring a boundary of an input coupling grating to correspond to a shape of an emission pupil while controlling curvature in corner regions of the boundary. The disclosed configurations increase coupling efficiency relative to circular boundaries while reducing image flare and diffraction artifacts associated with sharp-cornered rectangular boundaries. By enabling localized curvature control, including quadrant-specific curvature and directional curvature toward pupil expansion or output coupling gratings, the disclosed embodiments balance efficiency and image quality across a range of emission pupil shapes and orientations without requiring changes to the underlying waveguide architecture.

The preceding discussion is directed to various embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

Any one or more components of the various embodiments disclosed herein may be integrally formed together, directly coupled together, and/or indirectly coupled together and are not limited to the specific arrangement of components illustrated in FIGS. 1A-3C. Any one or more of the components, embodiments, or steps of the embodiments disclosed herein may be combined in whole or part with any other components, embodiments, or steps of the embodiments disclosed herein.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits, and ranges appear in one or more claims below.

In the preceding discussion and in the claims, the terms “including” and “comprising” are used in an open-ended fashion, and thus should be interpreted to mean “including, but not limited to. .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections.

Certain embodiments and features have been described using the term “about,” “generally,” “substantially,” and/or “generally.” When any of these terms are used in conjunction with a numerical value, it should be construed as indicating any numerical value within 10% of the stated numerical value.

While the foregoing is directed to embodiments of the present disclosure, other and further embodiments of the disclosure may be devised without departing from the basic scope thereof, and the scope thereof is determined by the claims that follow.

What is claimed is:

1. A waveguide, comprising:
an input coupling grating disposed on or in a waveguide substrate, the input coupling grating having a center point to be aligned with an emission pupil that is square or rectangular, the input coupling grating configured to receive the emission pupil and couple the emission pupil into the waveguide, wherein:
the input coupling grating has a boundary, the boundary includes four edge regions and four corner regions connecting adjacent edge regions, the corner regions defining a limiting boundary of the emission pupil; and
each respective corner region has a respective curve, each respective curve, in a local coordinate system, is defined by a curvature equation, xⁿ+yⁿ=Rⁿ, for a value of n, and
wherein x and y are orthogonal coordinates defined in the local coordinate system associated with the respective corner region, an origin of the local coordinate system located at the center point of the input coupling grating aligned with the emission pupil.

2. The waveguide of claim 1, wherein a first corner region is defined by the curvature equation having a first value of n and a second corner region is defined by the curvature equation having a second value of n different from the first value.

3. The waveguide of claim 1, wherein n is an integer from 2 to 100.

4. The waveguide of claim 1, wherein n is an even integer.

5. The waveguide of claim 1, wherein R is the same for each corner region and the value of n differs between at least two corner regions.

6. The waveguide of claim 1, wherein a corner region closest to a pupil expansion grating or an output coupling grating is defined by a curvature equation having a value of n greater than the value of n of the curvature equations of at least one other corner region.

7. The waveguide of claim 1, wherein the boundary is rotated relative to the waveguide to correspond to an orientation of the emission pupil.

8. The waveguide of claim 1, wherein the edge regions are substantially linear.

9. The waveguide of claim 1, wherein the limiting boundary of the emission pupil comprises four corners, and wherein each of the four corners coincides with a respective corner region of the boundary.

10. An optical device system, comprising:
a light engine configured to project an emission pupil that is square or rectangular;
a waveguide comprising an input coupling grating disposed on or in a waveguide substrate, the input coupling grating having a center point aligned with the light engine, the input coupling grating configured to receive the emission pupil and couple the emission pupil into the waveguide, wherein:
the input coupling grating has a boundary, the boundary includes four edge regions and four corner regions connecting adjacent edge regions, the corner regions defining a limiting boundary of the emission pupil; and
each respective corner region has a respective curve, each respective curve, in a local coordinate system, is defined by a curvature equation, xⁿ+yⁿ=Rⁿ, for a value of n, and
wherein x and y are orthogonal coordinates defined in the local coordinate system associated with the respective corner region, an origin of the local coordinate system located at the center point of the input coupling grating aligned with the emission pupil.

11. The optical device system of claim 10, wherein the boundary is rotated relative to the waveguide to correspond to an orientation of the emission pupil.

12. The optical device system of claim 10, wherein the edge regions are substantially linear.

13. The optical device system of claim 10, wherein a corner region positioned closest to a pupil expansion grating or an output coupling grating is defined by a curvature equation having a value of n greater than the value of n of the curvature equations of at least one other corner region.

14. The optical device system of claim 10, wherein n is an even integer and n is from 2 to 100.

15. The optical device system of claim 10, wherein a distance between the boundary and an edge of the emission pupil is within 10% of a width or height of the emission pupil.

16. A method of forming a waveguide, comprising:
measuring an area of an emission pupil of a light engine;
defining a boundary of an input coupling grating, the boundary including a plurality of edge regions and a plurality of corner regions connecting adjacent edge regions, the corner regions defining a limiting boundary of the emission pupil;
configuring the boundary to correspond to the area of the emission pupil by defining each respective corner region, each respective corner region having a respective curve, in a local coordinate system, defined by a curvature equation, xⁿ+yⁿ=Rⁿ, for a value of n,
wherein x and y are orthogonal coordinates defined in the local coordinate system associated with the respective corner region, an origin of the local coordinate system located at the center point of the input coupling grating aligned with the emission pupil; and
forming the input coupling grating having the boundary on a waveguide substrate.

17. The method of claim 16, wherein a first corner region is defined by the curvature equation having a first value of n and a second corner region is defined by the curvature equation having a second value of n different from the first value.

18. The method of claim 16, wherein configuring the boundary to correspond to the area of the emission pupil further comprises rotating the boundary to correspond to an orientation of the emission pupil.

19. The method of claim 16, wherein n is an integer from 2 to 100.

20. The method of claim 16, wherein n is an even integer.
